(19) United States
(12) Patent Application Publication
(10) Pub. No.: US 2024/0263512 A1
(43) Pub. Date: Aug. 8, 2024

(54) ROMAN BLIND

(71) Applicant: NINGBO LIYANG NEW MATERIAL COMPANY LIMITED, Ningbo, Zhejiang (CN)

(72) Inventor: Yongqiang ZHOU, Ningbo, Zhejiang (CN)

(21) Appl. No.: 18/569,513

(22) PCT Filed: Mar. 23, 2022
(86) PCT No.: PCT/CN2022/082458

§ 371 Date: Dec. 12, 2023

(30) Foreign Application Priority Data
Dec. 16, 2021 (CN) 202123199606.7

(51) Int. Cl. E06B 9/264; E06B 9/24; E06B 9/262; E06B 9/42; E06B 9/68; E06B 9/78

(52) U.S. Cl. CPC E06B 9/264; E06B 9/262; E06B 9/42; E06B 2009/2458; E06B 2009/2622; E06B 9/68; E06B 9/78

(57) ABSTRACT

A Roman blind incorporates an upper beam, a rolling tube, a Roman blind body, and a rolling body. Both ends of the rolling tube are connected to both ends of the upper beam respectively through a connection piece. An upper end of the rolling body is wound on the rolling tube. An upper end of the Roman blind body is fixed on the upper beam. A lower end of the rolling body ascends or descends synchronized with a lower end of the Roman blind body. A surface of the Roman blind body facing toward the rolling body includes a plurality of equally spaced limiting pieces. The lower end of the rolling body includes a drive piece cooperating with the limiting pieces to fold up the Roman blind body layer by layer from bottom up. The folding/unfolding of the Roman blind body is driven by the winding/unwinding of the rolling body, so that pull-rope-free winding/unwinding avoids potential safety hazards, the structure is simplified, the number of parts is small, assembly efficiency is higher, problems of the pull rope being easy to knot and to hook and break are solved, smoother usage is achieved, and the overall structure is neater and cleaner.

This application is a national stage application filed under 35 U.S.C 371 of International Application No. PCT Application No. PCT/CN2022/082458 filed on Mar. 23, 2022. The disclosures of the above applications are incorporated herein by reference in their entireties.

### TECHNICAL FIELD

The present disclosure relates to the field of curtain technologies and in particular to a Roman blind.

### BACKGROUND

Curtains are indispensable articles in houses and offices. The curtains are mainly used to adjust indoor light and protect privacy. The curtains may comprise roller blinds, venetian blinds, honeycomb blinds, and Roman blinds. The Roman blinds are very popular among people for its elegant and beautiful appearance. Further, they can fold up layer by layer at the time of folding up, giving a stereoscopic sense and a sense of luxury. Furthermore, the Roman blinds are made of various types of fabrics which can match indoor decorations. However, the Roman blinds also have some disadvantages, for example, the conventional Roman blinds are manually controlled to be rolled up an down by a pull rope. Since the Roman blinds are folded up layer by layer, a large segment gap between the pull rope and the Roman blind body and thus forms a loop. Therefore, there may be a risk of easily catching the necks of children playing around. For many Roman blinds on the market, structural improvements have been made for this safety problem. Due to complex structure, it is difficult to manufacture, process and assemble the Roman blinds. Further, there is also unsmooth problem in use. As a result, it is necessary to solve the above problem.

### SUMMARY

For the above problems in the prior arts, the present disclosure aims to provide a safe Roman blind which can be manufactured and assembled easily and used smoothly.

In order to address the above technical problems, the present disclosure provides the following technical solution: there is provided a Roman blind which comprises an upper beam, a rolling tube, a Roman blind body, and a rolling body. Both ends of the rolling tube are connected to both ends of the upper beam respectively through a connection piece. An upper end of the rolling body is wound on the rolling tube. An upper end of the Roman blind body is fixed on the upper beam. A lower end of the rolling body can ascend or descend in synchronization with a lower end of the Roman blind body. A surface of the Roman blind body facing toward the rolling body is provided with a plurality of limiting pieces arranged in equal spacing. The lower end of the rolling body is provided with a drive piece in cooperation with the limiting pieces to drive the Roman blind body to fold up layer by layer from bottom up.

Furthermore, the limiting pieces are elongated and horizontally disposed on the Roman blind body. Both ends of the limiting pieces are protruded outwardly along their thickness direction and fixedly connected to the Roman blind body. The limiting pieces are connected with the Roman blind body to enclose corresponding closed through grooves to allow the rolling body to run through freely but block the drive piece from running through.

Furthermore, the limiting pieces comprise two U-shaped clips symmetrically disposed. The U-shaped clips are fixedly connected to both sides of the Roman blind body. A U-shaped mouth in the U-shaped clips allows the rolling body to run through freely but blocks the drive piece from running through.

Furthermore, the drive piece is shaped like an elongated rod and disposed below the limiting pieces.

Furthermore, the drive piece is fixedly connected to the lower ends of the Roman blind body and the rolling body.

Furthermore, the width of the Roman blind body covers the upper beam and the connection pieces at both ends of the upper beam; the width of the rolling body is less than the width of the Roman blind body.

Furthermore, one of the connection pieces is provided with a pull bead component to drive the rolling tube to rotate.

Furthermore, one of the connection pieces is provided with a motor component to drive the rolling tube to rotate.

Compared with the prior arts, the present disclosure has the following advantages: in the present disclosure, as the rolling body is rolled up and down, the Roman blind body can be folded and unfolded. Thus, the folding and unfolding can be achieved without a pull rope, which avoids the hidden risk of catching the necks by the pull rope. The present disclosure is simple in structure, less in assembling parts and can be assembled more efficiently, which avoids the problems of easy knotting and easy breakage of the pull rope and ensures it is used more smoothly. Further, the entire structure is more tidy and cleaner.

### BRIEF DESCRIPTIONS OF THE DRAWINGS

In order to describe the technical solutions in the embodiments of the present disclosure or in the prior art more clearly, brief descriptions will be made below to the accompanying drawings involved in descriptions of the embodiments or the prior art. Obviously, the accompanying drawings are merely illustrative, and other drawings may also be obtained by those skilled in the art based on these drawings without paying creative work.

The structures, scales, sizes and the like depicted in the specification are only used by those skilled in the art to know and read the contents disclosed by the specification rather than to limit the embodiments of the present disclosure. Therefore, the structures, scales, sizes and the like do not have technically substantive meanings. Any modification, changes or adjustment to the structures, the scales and sizes shall all fall within the scope of protection covered by the technical contents disclosed by the present disclosure without affecting the effects and the purposes achieved by the present disclosure.

FIG. 1 is a schematic diagram illustrating a structure in an unfolded state according to an embodiment of the present disclosure.

FIG. 2 is a schematic diagram illustrating a structure in a folded state according to an embodiment of the present disclosure.

FIG. 3 is a schematic diagram illustrating a structure in an unfolded state according to another embodiment of the present disclosure.

FIG. 4 is a schematic diagram illustrating a structure in a folded state according to another embodiment of the present disclosure.

The numerals of the drawings are described below: 1. upper beam, 2. rolling tube, 3. Roman blind body, 4. rolling body, 5. connection piece, 6. limiting piece, 6.1 through groove, 6.2 U shaped mouth, and 7. drive piece.

### DETAILED DESCRIPTIONS OF EMBODIMENTS

The present disclosure will be further described below with reference to the specific embodiments.

In the descriptions of the present disclosure, it is understood that orientation or positional relationship indicated by the terms such as “central”, “longitudinal”, “transverse”, “length”, “width”, “thickness”, “upper”, “lower”, “front”, “rear”, “left”, “right”, “vertical”, “horizontal”, “top”, “bottom”, “inside”, “outside”, “clockwise”, “counterclockwise”, “axial”, “radial”, and “circumferential” is used only for ease of descriptions and simplification of descriptions and does not indicate or imply that the indicated devices or elements must have a particular orientation, or be constructed or operated in a particular orientation. Therefore, such terms shall not be understood as limiting of the present disclosure.

Further, the terms “first” and “second” are used for the purpose of descriptions only and shall not be understood as indicating or implying relative importance or implicitly indicating the number of the indicated features. As a result, the features defined by “first” and “second” may explicitly or implicitly include at least one feature. In the descriptions of the present disclosure, “several” refers to at least two, for example, two or three or the like, unless otherwise clearly stated.

In the present disclosure, unless otherwise clearly stated or defined, the terms “mount”, “connect”, “couple”, and “fix” and the like shall be understood in a broad sense, for example, may be fixed connection, or detachable connection, or formed into one piece; or may be mechanical connection, or electrical connection; or direct connection or indirect connection through an intermediate medium, or may be internal communication between two elements or mutual interaction of two elements, unless otherwise stated. Those skilled in the art may understand the specific meanings of the above terms in the present disclosure according to actual situations.

In the present disclosure, unless otherwise clearly stated or defined, the first feature being “on” or “below” the second feature refers to that the first feature and the second feature are in direct contact, or the first feature and the second feature are in indirect contact through an intermediate medium. Furthermore, the first feature being “above” or “on” the second feature refers to that the first feature is exactly above or obliquely above the second feature, or only refers to that the first feature has a higher horizontal height than the second feature. The first feature being “under” or “below” the second feature refers to that the first feature is exactly under or obliquely below the second feature, or only refers to that the first feature has a smaller horizontal height than the second feature.

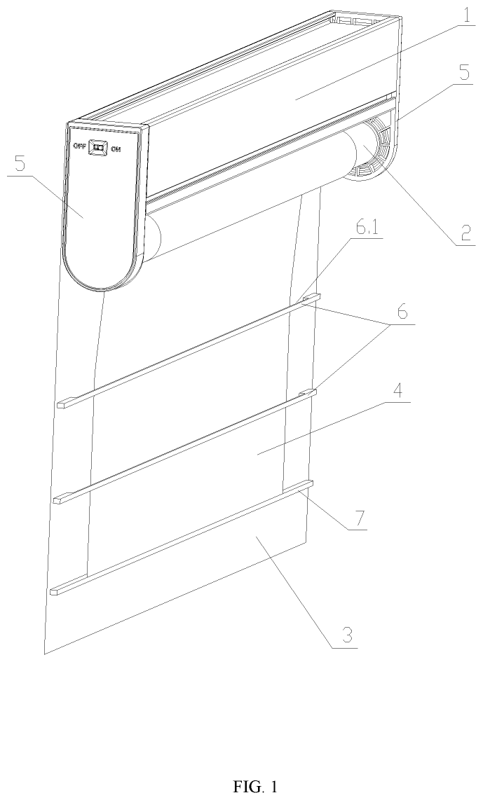

As shown in FIGS. 1 to 4, the present disclosure provides a Roman blind, which comprises an upper beam 1, a rolling tube 2, a Roman blind body 3, and a rolling body 4. Both ends of the rolling tube 1 are connected to both ends of the upper beam 1 respectively through a connection piece 1. An upper end of the rolling body 4 is wound on the rolling tube 2. An upper end of the Roman blind body 3 is fixed on the upper beam 1. A lower end of the rolling body 4 can ascend or descend in synchronization with a lower end of the Roman blind body 3. It should be noted that the lower end herein comprises a lowermost end and a part close to the lowermost end. A surface of the Roman blind body 3 facing toward the rolling body 4 is provided with a plurality of limiting pieces 6 arranged in equal spacing. The lower end of the rolling body 3 is provided with a drive piece 7 in cooperation with the limiting pieces 6 to drive the Roman blind body 3 to fold up layer by layer from bottom up.

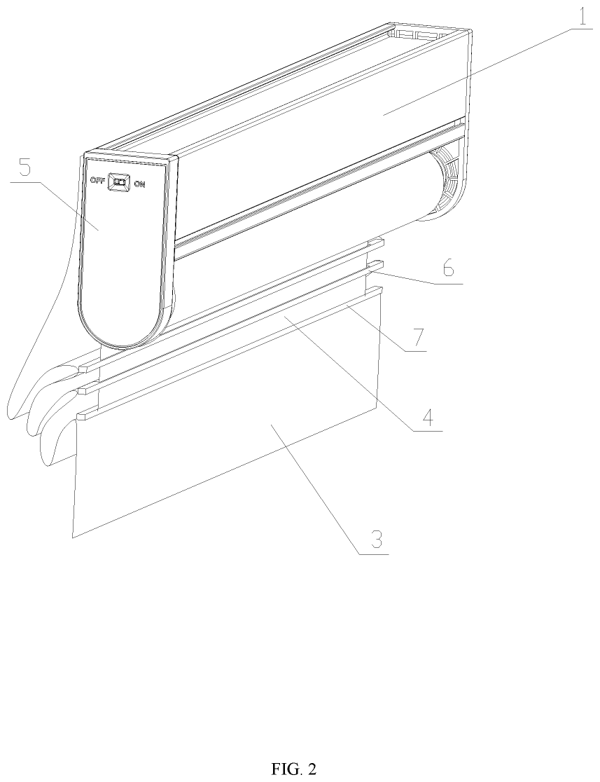

As a preferred embodiment, as shown in FIGS. 1 to 2, the limiting pieces 6 are elongated and horizontally disposed on the Roman blind body 3 such that the Roman blind body 3 can be horizontally unfolded without wrinkles. A length of the limiting pieces 6 is equal to or slightly less than a width of the Roman blind body 3. Both ends of the limiting pieces 6 are protruded outwardly along their thickness direction and fixedly connected to the Roman blind body 3. The limiting pieces 6 are connected with the Roman blind body 3 to enclose corresponding closed through grooves 6.1 to allow the rolling body 4 to run through freely but block the drive piece 7 from running through. In use, as the rolling body 4 is rolled up, the rolling body 4 can run through the through grooves 6.1 freely without affecting the rolling-up of the rolling body 4. When the drive piece 7 ascends to be against the limiting piece 6, since the drive piece 7 cannot run through the through groove 6.1, the drive piece 7 drives the limiting piece 6 to ascend together, so as to drive the Roman blind body 3 to be folded up. As the rolling body 4 is unfolded, the drive piece 7 descends along so as to allow the Roman blind body 3 to be unfolded layer by layer.

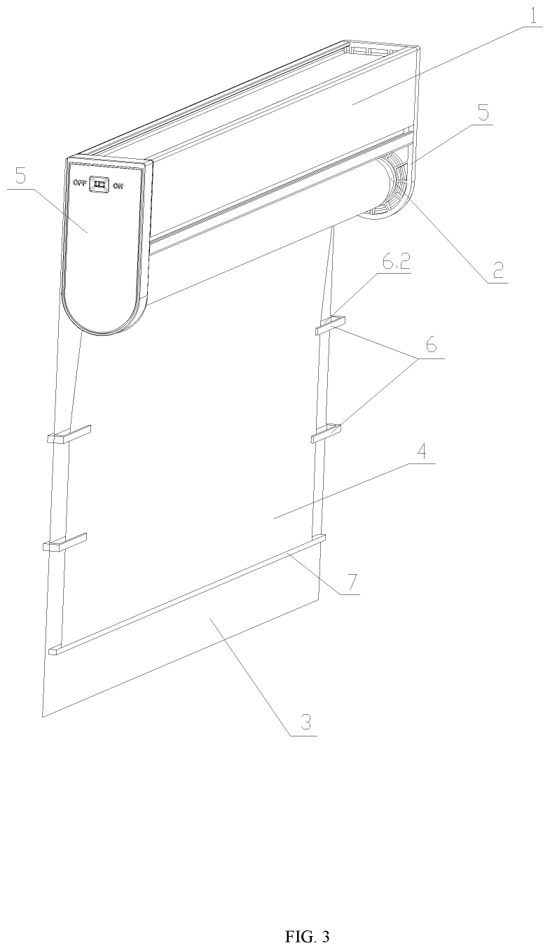

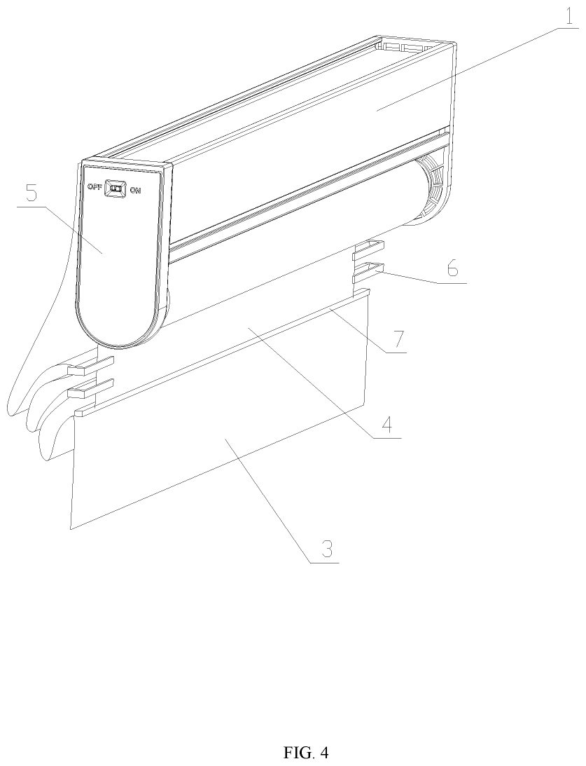

As a preferred embodiment of the present disclosure, as shown in FIGS. 3 to 4, the limiting pieces 6 comprise two U-shaped clips symmetrically disposed. The U-shaped clips are fixedly connected to both sides of the Roman blind body 3. A U-shaped mouth 6.2 in the U-shaped clips allows the rolling body 4 to run through freely but blocks the drive piece 7 from running through. In use, as the rolling body 4 is rolled up, the rolling body 4 can run through the U-shaped mouths 6.2 freely without affecting the rolling-up of the rolling body 4. When the drive piece 7 ascends to be against the limiting piece 6, since the drive piece 7 cannot run through the U-shaped mouths 6.2, the drive piece 7 drives the limiting piece 6 to ascend together, so as to drive the Roman blind body 3 to be folded up. As the rolling body 4 is unfolded, the drive piece 7 descends along so as to allow the Roman blind body 3 to be unfolded layer by layer.

The drive piece 7 is shaped like an elongated rod. The drive piece 7 is disposed below the limiting pieces 6. Along with the ascent of the drive piece 7, the limiting pieces 6 can be driven to ascend; along the descent of the drive piece 7, the limiting pieces 6 can be unfolded to a natural state. The drive piece 7 is preferably shaped like an elongated rod such that the rolling body 4 smoothly hangs down without wrinkles, leading to better aesthetics.

The drive piece 7 is fixedly connected to the lower ends of the Roman blind body 3 and the rolling body 4, such that the Roman blind body 3 and the rolling body 4 have better linkage. As the rolling body 4 ascends, the drive piece 7 can drive the Roman blind body 3 to be folded up at the same time.

The width of the Roman blind body 3 covers the upper beam 1 and the connection pieces 5 at both ends of the upper beam 1, and thus the entire structure is more tidy and beautiful. The width of the rolling body 4 is less than the width of the Roman blind body 3, and thus, the rolling body 4 can freely run through the limiting pieces 6 on the Roman blind body 3.

Preferably, one of the connection pieces 5 is provided with a pull bead component (not shown) to drive the rolling tube 2 to rotate. Hence, the people can manually control the ascent and descent of the rolling body 4 easily. The pull bead component is a commercially available product, which will not be redundantly described herein.

Preferably, one of the connection pieces 5 is provided with a motor component to drive the rolling tube 2 to rotate, so as to electrically control the ascent and descent of the rolling body 4. In this way, the Roman blind body 3 can be automatically folded and unfolded, leading to easy operation. The motor component may be a commercially available product which will not be redundantly described herein. The specific structure of the motor component is not shown in the drawings.

In the present disclosure, as the rolling body 4 is rolled up and down, the Roman blind body 3 can be folded and unfolded. Thus, the folding and unfolding can be achieved without a pull rope, which avoids the hidden risk of catching the necks by the pull rope. The present disclosure is simple in structure, less in assembling parts and can be assembled more efficiently, which avoids the problems of easy knotting and easy breakage of the pull rope and ensures it is used more smoothly. Further, the entire structure is more tidy and cleaner.

Finally, it should be noted that the above embodiments are used only to illustrate the technical solutions of the present disclosure rather than to limit the present disclosure. Although detailed descriptions are made to the present disclosure by referring to the above embodiments, those skilled in the art should understand that they can make changes to the technical solutions recorded in the preceding embodiments or make equivalent replacements to some technical features thereof. These changes or replacements will not cause the essence of the corresponding technical solutions to depart from the spirit and scope of the technical solutions of the embodiments of the present disclosure.

1. A Roman blind, comprising: an upper beam, a rolling tube, a Roman blind body, and a rolling body; wherein both ends of the rolling tube are connected to both ends of the upper beam respectively through a connection piece; an upper end of the rolling body is wound on the rolling tube;
an upper end of the Roman blind body is fixed on the upper beam;
a lower end of the rolling body can ascend or descend in synchronization with a lower end of the Roman blind body;
a surface of the Roman blind body facing toward the rolling body is provided with a plurality of limiting pieces arranged in equal spacing; and
the lower end of the rolling body is provided with a drive piece in cooperation with the limiting pieces to drive the Roman blind body to fold up layer by layer from bottom up.

2. The Roman blind of claim 1, wherein the limiting pieces are elongated and horizontally disposed on the Roman blind body; both ends of the limiting pieces are protruded outwardly along their thickness direction and fixedly connected to the Roman blind body; and the limiting pieces are connected with the Roman blind body to enclose corresponding closed through grooves to allow the rolling body to run through freely but block the drive piece from running through.

3. The Roman blind of claim 1, wherein the limiting pieces comprise two U-shape d clips symmetrically disposed; the U-shaped clips are fixedly connected to both sides of the Roman blind body; and a U-shaped mouth in the U-shaped clips allows the rolling body to run through freely but blocks the drive piece from running through.

4. The Roman blind of claim 2, wherein the drive piece is shaped like an elongated rod and disposed below the limiting pieces.

5. The Roman blind of claim 4, wherein the drive piece is fixedly connected to the lower ends of the Roman blind body and the rolling body.

6. The Roman blind of claim 1, wherein the width of the Roman blind body covers the upper beam and the connection pieces at both ends of the upper beam; and the width of the rolling body is less than the width of the Roman blind body.

7. The Roman blind of claim 1, wherein one of the connection pieces is provided with a pull bead component to drive the rolling tube to rotate.

8. The Roman blind of claim 1, wherein one of the connection pieces is provided with a motor component to drive the rolling tube to rotate.

9. The Roman blind of claim 3, wherein the drive piece is shaped like an elongated rod and disposed below the limiting pieces.

10. The Roman blind of claim 9, wherein the drive piece is fixedly connected to the lower ends of the Roman blind body and the rolling body.
